(19) United States
(12) Patent Application Publication
(10) Pub. No.: US 2010/0153184 A1
(43) Pub. Date: Jun. 17, 2010

(54) SYSTEM, METHOD AND COMPUTER PROGRAM PRODUCT FOR PREDICTING CUSTOMER BEHAVIOR

(75) Inventors: Andrew J. Caffrey, San Diego, CA (US); Karen C. Joiner-Congleton, San Diego, CA (US)

Correspondence Address: MUNSCH, HARDT, KOPF & HARR, P.C.;INTELLECTUAL PROPERTY DOCKET CLERK, 3800 LINCOLN PLAZA, 500N AKARD STREET, DALLAS, TX, 75201, US

(73) Assignee: STICS, Inc., San Diego, CA (US)

(21) Appl. No.: 12/620,315

(22) Filed: Nov. 17, 2009

Related U.S. Application Data
(60) Provisional application No. 61/115,318, filed on Nov. 17, 2008.

(51) Int. Cl. G06Q 10/00; G06Q 50/00; G06Q 30/00; G06F 17/30

(52) U.S. Cl. 705/10; 705/348; 705/14.41; 707/607; 707/E17.048; 707/E17.037

(57) ABSTRACT

According to one aspect of the present disclosure a method and technique for predictive modeling of customer behavior is disclosed. The method includes receiving customer data from a plurality on non-affiliated vendor properties, anonymizing at least a portion of the received customer data and merging the anonymized customer data from each vendor property into a consortium database, and generating at least one predictive model of at least one behavior variable associated with at least one customer represented in the consortium database, the predictive model enabling identification of at least one stimuli likely to affect a desired response by the customer based on the predictive model.

### CROSS-REFERENCE TO RELATED PATENT APPLICATIONS

This patent application claims the benefit of U.S. Provisional Patent Application No. 61/115,318, filed Nov. 17, 2008, the teachings and disclosure of which are hereby incorporated in their entireties by reference thereto.

### BACKGROUND

Vendors often retain a variety of types of information related to consumer or customer behavior. In some instances, the vendor uses this information to further promote their goods or services (e.g., in the nature of coupons, promotions and various types of incentives). The promotion or incentive may be part of an overall incentive program or may be a targeted program. Targeted programs sometimes attempt to target certain customers based on past customer behavior.

### BRIEF SUMMARY

According to one aspect of the present disclosure a method and technique for predictive modeling of customer behavior is disclosed. The method includes receiving customer data from a plurality on non-affiliated vendor properties, anonymizing at least a portion of the received customer data and merging the anonymized customer data from each vendor property into a consortium database, and generating at least one predictive model of at least one behavior variable associated with at least one customer represented in the consortium database, the predictive model enabling identification of at least one stimuli likely to impact a desired response by the customer based on the predictive model. In some embodiments, the customer data transfer is responsive to customer activity, thereby enabling dynamic predictive behavior modeling.

### BRIEF DESCRIPTION OF THE SEVERAL VIEWS OF THE DRAWINGS

For a more complete understanding of the present application, the objects and advantages thereof, reference is now made to the following descriptions taken in conjunction with the accompanying drawings, in which:

FIG. 1 is a diagram illustrating an embodiment of a consortium system for predicting customer behavior in accordance with the present disclosure;

FIG. 2 is a diagram illustrating an embodiment of a consortium system component of the system of FIG. 1 in accordance with the present disclosure;

FIG. 3 is a flow diagram illustrating an embodiment of a method for anonymizing vendor property data incorporated into a consortium database in accordance with the present disclosure;

FIG. 4 is a diagram illustrating a distribution of a customer's spending across different vendor properties in accordance with the present disclosure;

FIG. 5 is a flow diagram illustrating an embodiment of a predictive modeling method in accordance with the present disclosure;

FIG. 6 is a flow diagram illustrating an embodiment of a data delivery and preprocessing method in accordance with the present disclosure;

FIG. 7 is a flow diagram illustrating an embodiment of a data cleansing method in accordance with the present disclosure;

FIG. 8 is a flow diagram illustrating an embodiment of a data aggregation and variable derivation method in accordance with the present disclosure;

FIG. 9 is a flow diagram illustrating an embodiment of a stimulus-response categorization method in accordance with the present disclosure;

FIG. 10 is a flow diagram illustrating an embodiment of a cluster-level modeling method in accordance with the present disclosure; and

FIG. 11 is a flow diagram illustrating an embodiment of a model results delivery method in accordance with the present disclosure.

### DETAILED DESCRIPTION

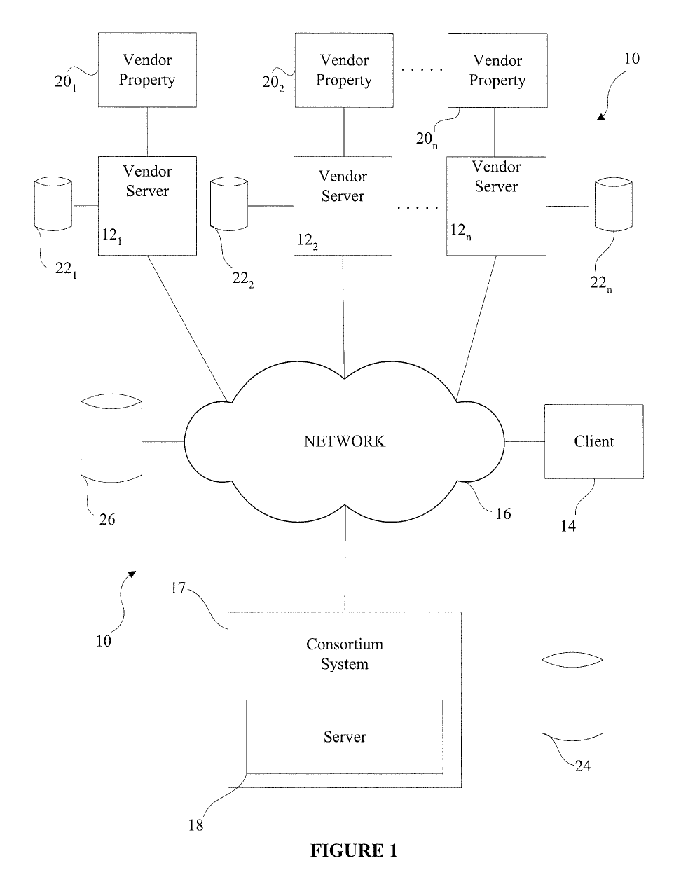

Referring now to FIG. 1, an embodiment of a consortium system 10 for predicting customer behavior is illustrated. As will be more fully explained below, system 10 is used to analyze various attributes associated with known and predicted customer behavior and generate predictive models related to the consumer's behavior. In some embodiments, consumer information is combined from a number of different affiliated or non-affiliated vendors to provide an enhanced view and/or understanding about past and predicted consumer behavior. System 10 may also be used to provide an enhanced understanding and predictive model for a customer's entertainment expenditures.

In the embodiment illustrated in FIG. 1, system 10 comprises vendor servers 12₁-12ₙ and a client 14 operably coupled through a network 16 to a consortium system 17 having a consortium server 18. Servers 12₁-12ₙ and 18 and client 14 may comprise any type of data processing platform. As illustrated in FIG. 1, each vendor server 12₁-12ₙ is associated with a particular vendor property 20₁-20ₙ (hereinafter referred to as a “property” or “properties” and used to identify a particular vendor entity or vendor field)). The vendor properties may be affiliated or non-affiliated. For example, the vendor properties may include one or more casino properties, one or more cruise line properties, one or more hotel properties, one or more restaurant properties, one or more retail properties, etc. It should also be understood that a particular vendor property may include any number of different services (e.g., a casino property may include gaming, hotel and restaurant services). Servers 12₁-12ₙ and 18 and client 14 may be equipped for wireless communication, wired communication, or a combination thereof, over network 16. Although a single client 14 is illustrated in FIG. 1, it should be understood that additional client 14 computer systems may be used. Also, it should be understood that functions corresponding to servers 12₁-12ₙ and 16 may be distributed among a multiple computing platforms.

In the embodiment illustrated in FIG. 1, each vendor property 20₁-20ₙ has associated therewith a customer database 22₁-22ₙ having information related to one or more customers of the respective property and accessible by corresponding servers 12₁-12ₙ. The information related to the property customer may vary. For example, for a casino-type of property, the data may include gaming or wagering data (e.g., session-level data such as dates and times of slot and/or table session, length of slot and/or table sessions, dollar value of coins inserted into slot machines and/or chips played at table games, dollar value of coins paid out by slot machines and/or chips won table games, dollar value of jackpots won, value of any complimentary slot or table play, and availability and use of credit or “front money”), hotel stay behavioral data (e.g., dates and lengths of hotel stays, size of rooms rented, smoking versus non-smoking, cost of rooms, amenities of property and room, and use of room service), and the types of offers/promotions made to various customers including the dollar amount of such offers/promotions and the offers/promotions accepted or redeemed by the customer. The customer data may also include retail sales information, food and beverage consumption information, and entertainment consumption information (e.g., dates of attendance, concerts and/or shows attended, sporting events attended, cost and number of tickets purchased, and values of related purchases). The customer data may also include various demographic and socio-economic data related to the customer (e.g., name, street address, city, state, zip code, email address, telephone number, social security number, gender, driver's license number, age, income, assets, home ownership, education level, and credit-worthiness and other demographic variables as may be individual-specific or apply to a geographic area in which each customer resides). It should be understood that the customer data may include other types of information depending on the information collected by the particular property as well as information related to the type of property (e.g., entertainment industry, hospitality industry, retail industry, etc.).

The customer data is communicated from the vendor properties to consortium server 18, where the data is stored in a consortium database 24. For example, in operation, each vendor property registers with consortium server to have its customer information evaluated in combination with customer information from other vendor properties to provide the registered vendor property with a better understanding of the customer's behavioral characteristics. As illustrated in FIG. 1, consortium system 17 may be configured to obtain additional information relative to various customers from a non-registered source or database 26, such as various types of publicly available information.

In FIG. 1, network 16 is the Internet, which is a global system of interconnected computer networks that interchange data by packet switching using the standardized Internet Protocol Suite (TCP/IP). In some embodiments, network 16 may be another suitable network such as, for example, a wide area network (WAN), local area network (LAN), intranet, extranet, etc., or any combination thereof. Network 16 is configured to facilitate wireless communication, wired communication, or a combination thereof, between servers 12₁-12ₙ and 16 and client 14.

In some embodiments, client 14 may comprise a desktop personal computer (PC). However, it should be understood that client 14 may be a variety of other network-enabled computing devices such as, for example, a server, laptop computer, notebook computer, tablet computer, personal digital assistant (PDA), wireless handheld device, cellular phone, and/or thin-client. Client 14 may be equipped for wireless communication, wired communication, or a combination thereof, over network 16. Client 14 may be used to communicate with consortium system 17 to input requests to consortium system 17 and/or receive information from consortium system 17.

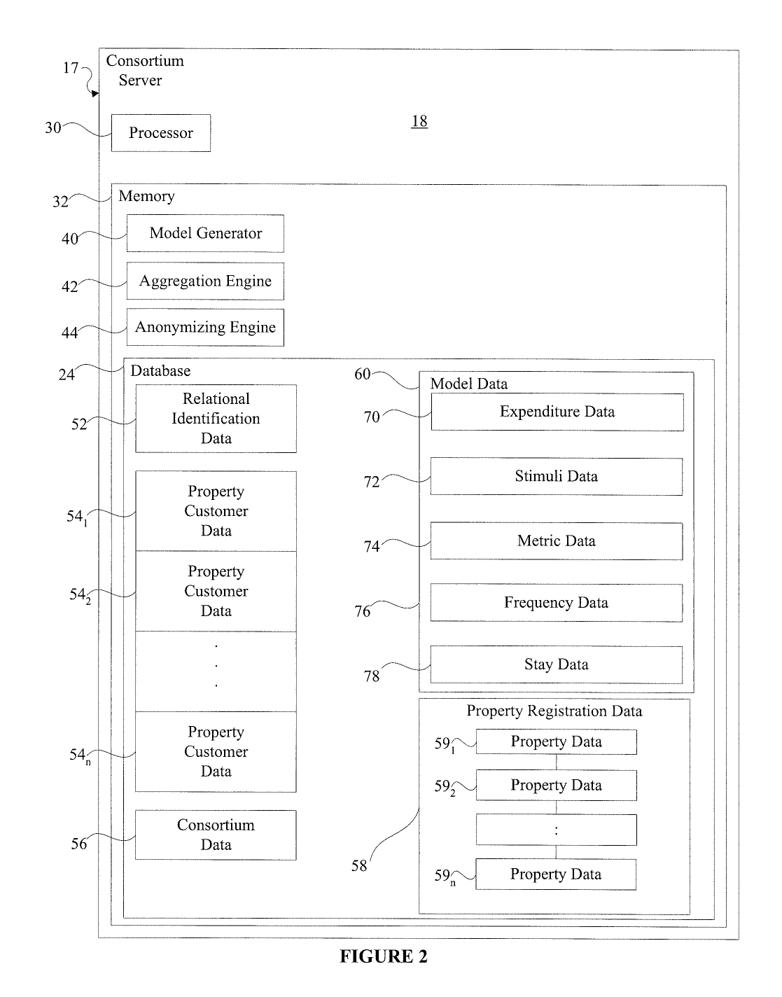

FIG. 2 is a diagram illustrating an embodiment of consortium system 17. In the embodiment illustrated in FIG. 2, consortium system 17 includes consortium server 18 having a processor 30 and memory 32. Processor may comprise any type of processing element configured to execute instructions. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer usable or computer readable medium(s) may be utilized. The computer readable medium may be a computer readable signal medium or a computer readable storage medium. A computer readable storage medium may be, for example but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with and instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present disclosure may be written in any combination of one or more programming languages. The program code may execute entirely on a single computer, partly on a single computer, as a stand-alone software package, partly on a single computer and partly on a remote computer or entirely on the remote computer or server.

In the embodiment illustrated in FIG. 2, memory 32 has stored therein a model generator 40, an aggregation engine 42, and an anonymizing engine 44. Model generator 40 and engines 42 and 44 may comprise executable instructions for carrying out various processes with respect to customer data received from each vendor property. In the embodiment illustrated in FIG. 2, server 18 also comprises database 24 having relational identification data 52, property data 54₁-54ₙ, consortium data 56, property registration data 58, and model data 60. Relational identification data 52 comprises information relating various customers whose behavioral data has been received by system 17 to a particular vendor property. Relational identification data 52 may also comprise identification information for identifying each particular vendor property and/or customer of a particular vendor property. For example, relational identification data 52 may comprise one or more lookup tables corresponding to each vendor property enabling a mapping of a vendor property identification (ID) to a corresponding ID representing that vendor property in consortium data 56. Similarly, relational identification data 52 may comprise one or more lookup tables relating a property-level customer ID corresponding to a particular vendor property's customer to that customer's ID represented in consortium data 56.

Property data 54₁-54ₙ comprises the customer behavioral information received from each vendor property by system 17. Consortium data 56 comprises an aggregation of data relating to the customers of the various vendor properties that has been processed by one or more of engines 42 and 44. Property registration data 58 comprises information associated with each registered vendor property supplying information to system 17. In the embodiment illustrated in FIG. 2, property registration data 58 includes property data 59₁-59ₙ corresponding to each vendor property. Property data 59₁-59ₙ comprises various types of information related to the respective vendor properties that may be analyzed, combined or otherwise evaluated that may impact customer behavior and/or affect a customer's response to various types of incentives/promotions. For example, property data 59₁-59ₙ may include information such as, but not limited to: property ownership; financial conditions of income statement and balance sheet for a particular vendor property; management, operations, corporate strategies, characteristics, appearance, and size of property (e.g., in a casino, the number of gaming machines); number of employees; income; and qualitative characterization of the feel or brand of the vendor property. Property data 59₁-59ₙ may be submitted to consortium system 17 by respective properties (e.g., via network 16), may be gathered and input to consortium system 17 from other sources (e.g., customer feedback/opinion surveys, public financial statements, etc.), or may be otherwise received, gathered and/or input to consortium system 17. Various types of information as stored as property data 59₁-59ₙ may also be included as consortium data 56 and evaluated in combination with customer data 52₁-52ₙ.

Model data 60 comprises information associated with various customer behavioral models derived by model generator 40 using information contained in consortium data 56. Aggregation engine 42 performs various operations on the customer information received from each vendor property such as formatting, translating and/or otherwise manipulating the different types of information to enable the information to be analyzed and model data 60 generated. As will be described further below, various types of information received from the vendor properties is anonymized prior to or at the time of aggregation with other vendor property information by anonymizing engine 44.

Model data 60 comprises various types of predictive models generated by model generator 40 based on information contained in consortium data 56. Model data 60 generally comprises predictive models about customer behavior based at least partly on historic customer behavior and predicted future customer behavior. In the embodiment illustrated in FIG. 2, model data 60 comprises expenditure data 70, stimuli data 72, metric data 74, frequency data 76 and stay data 78. Expenditure data 70 may comprise a predictive model directed toward customer worth and/or predicted expenditures by a particular customer, and may also be expressed as a customer's entertainment “wallet.” For example, “wallet” may be used to describe a customer's potential to spend money and is distinct from the actual spending that a customer may undertake. Estimating the available and practical size of the customer's wallet is created and may utilize available data from various profile elements (e.g., the customer's past spending patterns and socioeconomic status).

Stimuli data 72 may comprise a model estimating and/or predicting the probability of the acceptance or redemption of promotional offers made to the customer. For example, stimuli and response data may be classified according to its native dimensions (as recorded by the individual vendor property), but may be reclassified into a unique cross-vendor, cross-industry solicitation and response classification system of many dimensions. This method for integrating different stimuli experienced by customers and vendor properties classifies each stimulus and response across different time scales, different media delivery options, and different spending options. Classifying stimuli and response data may take place within and across vendor properties, and promotion programs may be evaluated in multiple dimensions (e.g., value of offer, timing of offer, offer durability, frequency the offer is made, selected media for delivery of the offer, tenure of the offer, uniqueness of the offer, offer liquidity, and access to the offer). In other words, an offer or contact with a customer is characterized based upon when the contact is made, how long the offer is good for, how frequently the offer is made, the media in which the offer is delivered, the tenure of the offer itself, the uniqueness of the offer among offers, the nearness of the offer to disposable income, the access the customer is given to the offer itself, etc. It should be understood that other dimensions of offer characterization may also be generated/used.

Frequency data 76 may comprise a model predicting and/or estimating a customer's frequency of taking part in some particular activity, such as an entertainment activity (ID, gaming, concert attendance, hotel stays, etc.). Metric data 74 may comprise information associated with combining various types of model data into a single metric characterizing each customer it represented in consortium data 56. The metric may take the form of a rank, score, or dollar value according to a particular desire end use. Stay data 78 may comprise a predictive model directed toward a customer's hotel or vacation tendencies. It should be understood that other types of [predictive models may also be generated.

In operation, each of the different types of data received from vendor properties may be formatted differently and may be represented in different units of measure. Aggregation engine 42 matches, translates and/or otherwise processes the data received from the various vendor properties for inclusion into consortium data 56. For example, similar types of data may correspond to different vendors (e.g., different hotel chains). A particular customer's hotel stay behavior may be represented in computer format comprising different fields of information, different field designations, and different units of measure. As an illustrative example, one vendor may log the duration of a hotel stay in hours while another vendor may log the duration of a hotel stay in minutes. In the process of creating consortium data 56, aggregation engine 42 matches various data fields and/or translates information into like units of measure.

Aggregation engine also merges dissimilar data types. For example, information related to gaming behaviors may be represented in a data format having fields such as: ID, name, slotwin, tablewin, slottim, and tabletim. A customer's demographic information may be represented in a format having fields such as: ID, name, address, zip, gender, and marital status. Data fields with similar information are matched and translated so that the information in the resulting merged database is consistent across observations. As an example, consider that the name data field from one vendor property is formatted “Last Name, First Name, Middle Name”, while the name data field from another vendor property is formatted “First Name, Middle Name, Last Name.” Aggregation engine translates these name fields to be in a like format, for example by re-formatting the name data field of one of the vendors to “Last Name, First Name, Middle Name.” The resulting merged data 56 thus includes the following fields: name (formatted as “Last Name, First Name, Middle Name”), slotwin, tablewin, slottim, tabletim, address, zip, gender, and marital status.

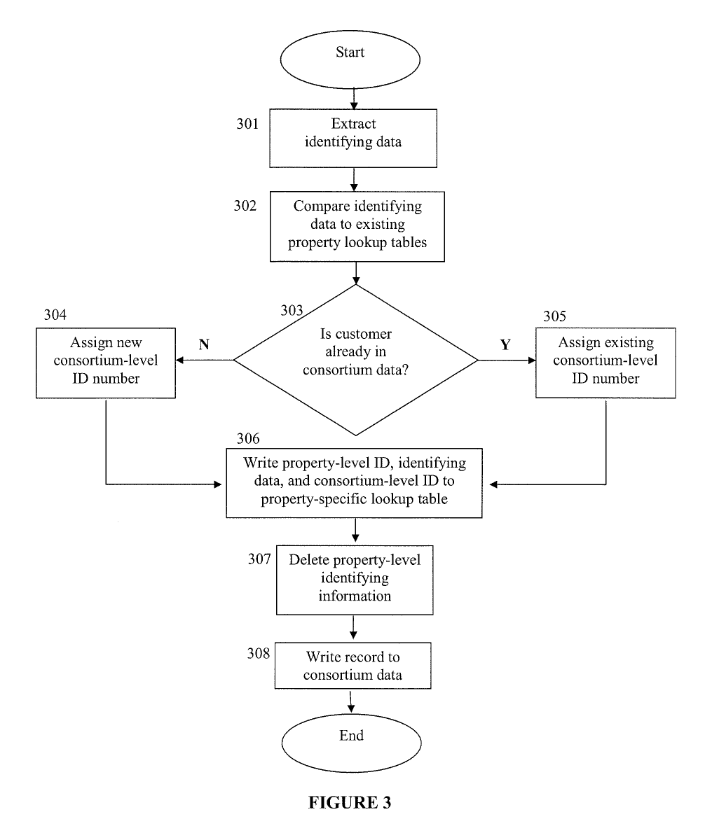

FIG. 3 is a flow diagram illustrating an embodiment of a method for anonymizing vendor property data incorporated into consortium data 56 (e.g., performed by anonymizing engine 44). According to some embodiments, identifiable vendor property data is anonymized as the combined vendor property data is incorporated into consortium data 56. However, it should be understood that vendor data may be anonymized as component data types are matched and merged into consortium data 56. Aspects of the present disclosure anonymize certain types of identification information at any point prior to or during incorporation of the vendor data into consortium data 56. However, it should be understood that the anonymizing of data may be performed prior to and/or after data has been stored as consortium data 56.

The method begins at block 301, where certain types of identifying information is extracted from vendor property data 54₁-54ₙ. This extracted information may include an identification (ID) number used to identify a particular vendor property 20₁-20ₙ, customer information such as name, address, telephone number, email address, social security number, and any other data fields that may be useful in matching identities of customers across dissimilar data sources. At block 302, the extracted identifying information is compared to identifying information contained in separate lookup tables for each vendor property (e.g., relational identification data 52). At decisional block 303, a determination is made whether any extracted identifying information from a particular vendor property data matches identifying information already contained in another vendor property's data lookup table (i.e., indicating that another vendor may have already submitted some type of information related to the same customer). If a match is found in an existing vendor property lookup table, a consortium ID number previously assigned to the corresponding information is assigned to the current record at block 305. If no match is found, a new consortium ID number is assigned to the current record at block 304. At block 306, a property-level ID number (e.g., an ID number assigned to a particular vendor property and used to identify the particular vendor property), identifying information, and newly-assigned consortium ID number are written to the vendor property-specific lookup table in relational identification data 52. Identifying data fields and property-level ID number are then deleted from the current record at block 307, and the current record is written to consortium data 56 at block 308. According to some embodiments of the present disclosure, each unique customer or individual in the consortium data 56 is identified by a unique consortium ID number such that little or no other direct identifying information is contained in the consortium data 56. This consortium ID number maps to a record in a lookup table for each of the vendor properties contributing data relevant to that particular customer.

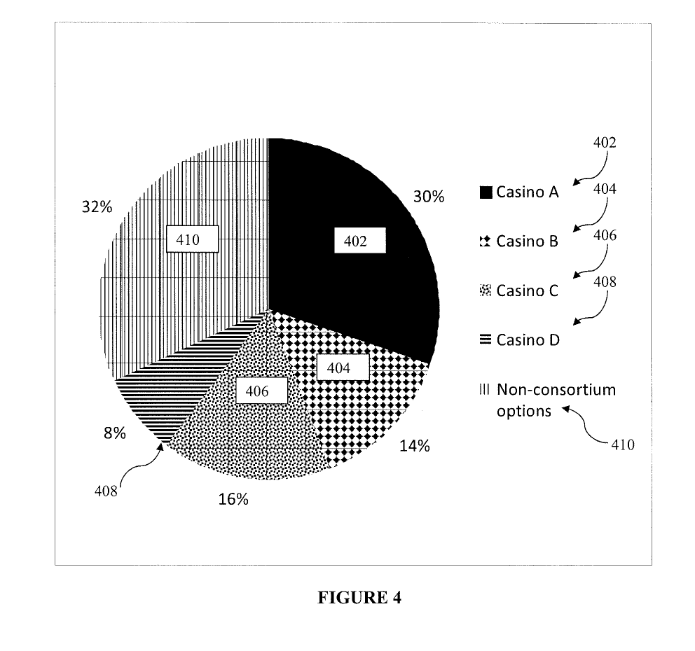

FIG. 4 is a diagram illustrating the distribution of a customer's spending across different vendor properties using aspects of the present disclosure. In this illustrative example, four vendor properties are represented as Casino A 402, Casino B 404, Casino C 406, and Casino D 408. Other expenditure options related to non-registered vendor properties are identified as non-consortium options 410. In operation, model generator 40 evaluates consortium data 56 and generates expenditure model data 70 illustrating a particular customer's entertainment wallet flowing to consortium vendor registered properties and to non-consortium options. The determination of non-consortium property expenditures may be based on a variety of factors such as, but not limited to, an estimation of a particular customer's entertainment spending over some time interval, annual income data related to the customer, the amount of wagering losses over a period of time, etc. The expenditure model data 70 is provided to registered consortium vendor properties to enable the vendor properties better target their promotional and advertising efforts to this customer.

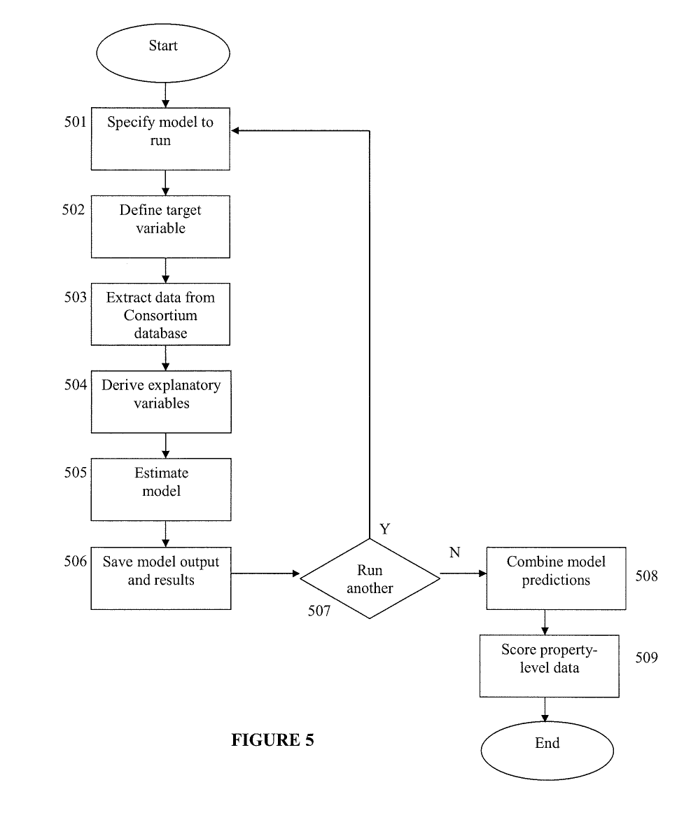

FIG. 5 is a flow diagram illustrating an embodiment of a predictive modeling method according to the present disclosure. At block 501, the particular model to be estimated, evaluated and/or otherwise generated is specified/identified. In some embodiments, in a casino industry example, models to be generated may include an expenditure model 70, a frequency model 76 and a stimuli model 72; however, it should be understood that a other and/or additional models may be developed and may vary based on the particular application. In this example, the expenditure model 70 may be directed toward modeling customer worth, the frequency model 76 may be directed toward gaming frequency for a particular customer, and stimuli model 72 may be directed toward modeling the probability of a desired response to promotional offers made to the particular customer. At block 502, the target variable(s) is defined. In some embodiments, a target variable for customer worth may be defined as:

worth=average daily gaming loss*number of expected gaming days per year;

a target variable for gaming frequency may be defined as:

daysplayed=number of expected gaming days per year;

and a target variable for offer response may be defined as:

response=probability customer will respond to a promotional offer.

At block 503, data is extracted from consortium data 56. Extracted variables include those deemed to have significant power to explain variation in the relevant target variable, denoted “explanatory variables”. According to some embodiments, additional explanatory variables are derived from the raw variables extracted from the consortium data 56. These variables may include, but may not be limited to, those variables listed in Table 1 below:

TABLE 1

| Variable | |
|---|---|
| Name | Description |
| ID | Consortium ID Number |
| age | Age of Player |
| adw | Average Daily Worth |
| avplydys | Average days played during trip |
| aslottim | Average length of a days play |
| aslttiot | Average length of a days play at other properties |
| asltti8 | Average length of a days play at property |
| atabltim | Average length of a days table play |
| atabtiot | Average length of a days table play at other properties |
| atabti8 | Average length of a days table play at property |
| aslotgam | Average number of Slot Games per Session |
| aslotses | Average number of slot sessions a day |
| atablgam | Average number of Table Games per Session |
| atablses | Average number of table sessions a day |
| avplyp | Average of play days as % of trip length |
| avstyply | Average of stay days as % of play days |
| avstyp | Average of stay days as % of trip length |
| avstydys | Average stay days during trip |
| avtrpdys | Average trip length |
| creditli | CreditLine |
| datetrip | Date of last trip |
| dateenro | DateEnrolled |
| day_n | Day Number (During Trip) |
| tnur | Days as customer between enrollment and last “current trip date” |
| tnurgrp | Days as customer bucketized between enrollment and last “current trip date” |
| awolgrp | Days Away buckets since last “current trip date” |
| awol | Days Away since last “current trip date” |
| bndayago | Days since last played, by bins |
| distgrp | Distance Buckets for logical groups of miles |
| dollarva | Dollar Value of Coupons Granted |
| coups_$ | Dollar Value of Coupons Redeemed |
| enrollme | EnrollmentSource |
| favorite | FavoriteGame |
| mntrip_e | First trip end of trip date |
| mntrip_b | First trip start of trip date |
| zip | Five Digit USA only Zip code |
| atniter | Flag = 1 if 50% or more play after 4pm |
| everstad | Flag = 1 if ever stayed in property being modeled |
| mxrspses | Flag = 1 if has coupon or promo in sessions file |
| respprom | Flag = 1 if has positive response in pomo file |
| dupid | Flag = 1 if player has a duplicate ID |
| female | Flag = 1 if player is Female |
| hosted | Flag = 1 if player is hosted |
| linked | Flag = 1 if player is linked to another player |
| male | Flag = 1 is Male |
| frontmon | FrontMoney |
| credtusr | Has a credit activity file record |
| onetimer | Is one if only one day played |
| mialocal | Is one if player is local and not back in 90 days |
| miaunlcl | Is one if player is not local and not back in 180 days |
| wkdayer | Is one if week day play >=60% |
| mxtrip_b | Last end of trip date |
| mxtrip_e | Last trip end of trip date |
| localmkt | Local Mkt |
| loc_flag | Local/Non-Local (1 =< 100 mi/0 = 100+ mi/9 DK) |
| mxtrpdys | Longest trip length |
| marriage | marriage_date |
| mx_st_12 | Max of number of promos in last 12 months = max(snt_12) |
| mx_st_24 | Max of number of promos in last 24 months = max(snt_24) |
| mx_st_3 | Max of number of promos in last 3 months = max(snt_3) |
| mx_st_36 | Max of number of promos in last 36 months = max(snt_36) |
| mx_st_48 | Max of number of promos in last 48 months = max(snt_48) |
| mx_st_6 | Max of number of promos in last 6 months = max(snt_6) |
| mx_st_9 | Max of number of promos in last 9 months = max(snt_9) |
| mxbon23 | Max of Amount from BonusID = 2 ActionID = 3 |
| mxbon24 | Max of Amount from BonusID = 2 ActionID = 4 |
| mxbon27 | Max of Amount from BonusID = 2 ActionID = 7 |
| mxbon28 | Max of Amount from BonusID = 2 ActionID = 8 |
| mxbon33 | Max of Amount from BonusID = 3 ActionID = 3 |
| maxadw | Max of Daily Worth |
| mxda_ago | Max of Days since Last Visit |
| mxncoups | Max of number of Coupons Redeemed |
| mxnpromo | Max of number of Promo Redeemed |
| mxplyp | Max of play days as % of trip length |
| mxprog | Max of Progress = max(m_prog) |
| mxredemp | Max of RedemptionDollarValue |
| mxsltcoi | Max of Slot_CoinIn |
| mxsltc1 | Max of Slot_CoinOut |
| mxsltgam | Max of Slot_Games |
| mxsltjac | Max of Slot_Jackpot |
| mxsltses | Max of Slot_Sessions |
| mxsltthe | Max of Slot_TheoWin |
| mxslttim | Max of Slot_TimePlayed |
| mxstyply | Max of stay days as % of play days |
| mxstyp | Max of stay days as % of trip length |
| mxtbl_ga | Max of Table_Games |
| mxtbl_se | Max of Table_Sessions |
| mxtbl_th | Max of Table_TheoWin |
| mxtbl_ti | Max of Table_TimePlayed |
| mxtbl_wi | Max of Table_Win |
| s_s_cats | Max promo cats across = sum(sum_cats) |
| mxs_cats | Max promo cats across all promos = max(sum_cats) |
| mxs_catz | Max promo cats across all promos redeemed = max(Zsum_cat) |
| mxplydys | Maximum of days played during trip |
| mxstydys | Maximum of stay days during trip |
| avprog | Mean of Progress = mean(m_prog) |
| atlcity | Miles to Atlantic City |
| distance | Miles to property |
| reno | Miles to Reno |
| strip | Miles to Strip |
| mn_rd_12 | Min of number of promos redeemed in last 12 months = min(red_12) |
| mn_rd_24 | Min of number of promos redeemed in last 24 months = min(red_24) |
| mn_rd_3 | Min of number of promos redeemed in last 3 months = min(red_3) |
| mn_rd_36 | Min of number of promos redeemed in last 36 months = min(red_36) |
| mn_rd_48 | Min of number of promos redeemed in last 48 months = min(red_48) |
| mn_rd_6 | Min of number of promos redeemed in last 6 months = min(red_6) |
| mn_rd_9 | Min of number of promos redeemed in last 9 months = min(red_9) |
| minadw | Min of Daily Worth |
| mnda_ago | Min of Days since Last Visit |
| mnncoups | Min of number of Coupons Redeemed |
| mnnpromo | Min of number of Promo Redeemed |
| mnoutlk | Min of Outlook = min(m_outlk) |
| mnplyp | Min of play days as % of trip length |
| mnredemp | Min of Redemption Dollar Value |
| mnsltcoi | Min of Slot CoinIn |
| mnsltc1 | Min of Slot CoinOut |
| mnsltgam | Min of Slot Games |
| mnsltjac | Min of Slot Jackpot |
| mnsltses | Min of Slot Sessions |
| mnsltthe | Min of Slot TheoWin |
| mnslttim | Min of Slot TimePlayed |
| mnstyply | Min of stay days as % of play days |
| mnstyp | Min of stay days as % of trip length |
| mntbl_ga | Min of Table Games |
| mntbl_se | Min of Table Sessions |
| mntbl_th | Min of Table TheoWin |
| mntbl_ti | Min of Table TimePlayed |
| mntbl_wi | Min of Table Win |
| mns_cats | Min promo cats = min(sum_cats) |
| mns_catz | Min promo cats redeemed = min(Zsum_cat) |
| mnplydys | Minimum of days played during trip |
| mnstydys | Minimum of stay days during trip |
| s_air | Number of Air promos = sum(air_all) |
| coups_r | Number of Coupons Redeemed |
| daysplad | Number of days played at property |
| freqdays | Number of days visitied |
| s_events | Number of Event/Entertainment promos = sum(events) |
| s_cash | Number of Free Cash promos = sum(cash) |
| s_sltply | Number of Free Slot Play promos = sum(slotplay) |
| s_stay | Number of Hotel/Stay promos = sum(stay) |
| nposresp | Number of Positive Responses to Promos |
| n_promo | Number of promos = n(promoid) |
| s_f_b | Number of promos = sum(f_b) |
| s_tblply | Number of promos Free Table Play = sum(chips) |
| promos_r | Number of Promos Redeemed |
| s_spaetc | Number of Spa Retail and Golf promos = sum(spashpgf) |
| s_tmpcns | Number of time-constrained promos = sum(tmpcnstr) |
| s_tourn1 | Number of tournament promos = sum(tourn1) |
| s_trans | Number of transport promos = sum(transprt). |
| numtrips | Number of Trips |
| adwop | Pc of ADW at other properties |
| slthop | Pc of Slot TheoWin at other properties |
| adwp | Pct of ADW at property |
| asltiop | Pct of slot play length at other props to tot |
| asltip | Pct of slot play length at property to total |
| slthp | Pct of Slot TheoWin at property |
| atbtiop | Pct of table play length at other props to total |
| atbtip | Pct of table play length at property to total |
| tbthop | Pct of Table TheoWin at other properties |
| tbthp | Pct of Table TheoWin at property |
| r_events | Percent of offered Event/Entertainment promos redeemed |
| r_f_b | Percent of offered Food/Beverage promos redeemed |
| r_cash | Percent of offered Free Cash promos redeemed |
| r_sltply | Percent of offered Free Slot Play promos redeemed |
| r_tblply | Percent of offered Free Table Play promos redeemed |
| r_s_cats | Percent of offered promos redeemed |
| r_spaetc | Percent of offered Spa Retail and Golf promos redeemed |
| r_stay | Percent of offered Stay-related promos redeemed |
| r_tmpcns | Percent of offered Time-Constrained promos redeemed |
| r_tourn1 | Percent of offered Tournament promos redeemed |
| r_trans | Percent of offered Transport promos redeemed |
| wkdaydom | Percent of play days during the week |
| nightdom | Percent of play days started after 4 pm |
| y_f_b | Percent of promos offered as Food/Beverage |
| y_cash | Percent of promos offered as Free Cash |
| y_sltply | Percent of promos offered as Free Slot Play |
| y_tblply | Percent of promos offered as Free Table Play |
| y_spaetc | Percent of promos offered as Spa Retail and Golf |
| y_stay | Percent of promos offered as Stay-related |
| y_tmpcns | Percent of promos offered as Time-Constrained |
| y_tourn1 | Percent of promos offered as Tournament |
| y_trans | Percent of promos offered as Transport |
| y_events | Percent of promos offered Event/Entertainment |
| pctinYYYY | Percentof days played in year YYYY (for all years available) |
| phone_ty | Phone ype |
| plrtype | Playeryype |
| worst1st | Promo category least likely to respond to |
| worst2nd | Promo category least most likely to respond to |
| worst3rd | Promo category least most likely to respond to |
| best1st | Promo category most likely to respond to |
| best2nd | Promo category second most likely to respond to |
| best3rd | Promo category third most likely to respond to |
| promoted | PromoteDemoteRating |
| siteid | PropertyID |
| rating | Rating |
| rsprtses | Ratio of npromo + ncoup to Player Promo presence |
| rsprtpro | Ratio of Promos with positive status to total promos |
| endtime | Session EndTime |
| starttim | Session start time |
| mntrpdys | Shortest trip length |
| slot_cmp | Slot Comps granted |
| slotcomp | Slot Comp Used |
| biloxisq | Square of distance from property |
| stripsq | Square of distance from Vegas |
| marrydt | Stated date of marriage |
| bonact23 | Sum of Amount from BonusID = 2 ActionID = 3 |
| bonact24 | Sum of Amount from BonusID = 2 ActionID = 4 |
| bonact27 | Sum of Amount from BonusID = 2 ActionID = 7 |
| bonact28 | Sum of Amount from BonusID = 2 ActionID = 8 |
| bonact33 | Sum of Amount from BonusID = 3 ActionID = 3 |
| sumadw | Sum of Daily Worth |
| sadwothr | Sum of Daily Worth at other properties |
| sadw8 | Sum of Daily Worth at property |
| splydys | Sum of days played during trips |
| days_ago | Sum of Days since Last Visit |
| n_coups | Sum of number of Coupons Redeemed |
| n_promos | Sum of number of Promo Redeemed |
| redempti | Sum of RedemptionDollarValue |
| slot_coi | Sum of Slot CoinIn |
| slot_c1 | Sum of Slot CoinOut |
| slot_gam | Sum of Slot Games |
| slot_jac | Sum of Slot Jackpot |
| slot_ses | Sum of Slot Sessions |
| slot_the | Sum of Slot TheoWin |
| sltthoth | Sum of Slot TheoWin at other properties |
| sltth8 | Sum of Slot TheoWin at property |
| slot_tim | Sum of Slot TimePlayed |
| sstydys | Sum of stay days during trips |
| table_ga | Sum of Table Games |
| table_se | Sum of Table Sessions |
| table_th | Sum of Table TheoWin |
| tabthoth | Sum of Table TheoWin at other properties |
| tabth8 | Sum of Table TheoWin at property |
| table_ti | Sum of Table TimePlayed |
| table_wi | Sum of Table Win |
| strpdys | Sum of trip lengths |
| table_cmp | Table Comps Granted |
| tablecom | Table Comp Used |
| urban | Top 4 MSA Cats |
| worth | Total ADW across all properties |
| tot_resp | Total number of Promos (any response) |
| trip_n | Trip Number |

Other explanatory variables may also be derived from the raw variables extracted from the consortium data 56. For example, variables related to a hotel or resort stay may include those variables listed in Table 2 below:

TABLE 2

| | |
|---|---|
| staydays | Number of days logding at resort |
| staynbr | Cumulative value assigned to each unique resort visit |
| stayextnd | Flag = 1 if guest extended visit beyond original reservation |
| staytype | Flag = 1 if visit initiated without reservation |
| staybeg | Date current visit began |
| staydate | Date of individual stay day |
| staydayn | Day number within stay (1 = first day, 2 = second day, etc) |
| stayend | Date current visit concluded |
| staysts | Status of reservation (No Show, Canceled, Checked Out) |
| stayadlts | Number of adults this visit |
| staychld | Number of children this visit |
| staycmp1 | Daily room rate amount charged to comp |
| staycmp2 | Daily room upsell amount charged to comp |
| staycmp3 | Daily misc room amount charged to comp |
| staycmp4 | Daily food and/or beverage amount charged to comp |
| staycmp5 | Daily spa amount charged to comp |
| staycmp6 | Daily retail amount charged to comp |
| staycmp7 | Daily golf amount charged to comp |
| staycmp8 | Daily airfare amount charged to comp |
| staycmp9 | Daily resort fee amount charged to comp |
| staycmp0 | Daily other amount charged to comp |
| stayrev1 | Daily room rate amount recorded as revenue |
| stayrev2 | Daily room upsell amount recorded as revenue |
| stayrev3 | Daily misc room amount recorded as revenue |
| stayrev4 | Daily food and/or beverage amount recorded as revenue |
| stayrev5 | Daily spa amount recorded as revenue |
| stayrev6 | Daily retail amount recorded as revenue |
| stayrev7 | Daily golf amount recorded as revenue |
| stayrev8 | Daily airfare amount recorded as revenue |
| stayrev9 | Daily resort fee amount recorded as revenue |
| stayrev0 | Daily other amount recorded as revenue |
| staycmps | Total amount charged to comp |
| stayrevs | Total amount recorded as revenue |
| stayrmcg | Room category this visit (Suite, Luxury Suite, etc) |
| roommrgn | Daily difference between comped |
| | room value and retail room value |
| staymrgn | Difference between comped room value |
| | and retail room value for visit |

An exemplary listing of different variables that may be included in consortium data 56 and evaluated according to aspects of the present disclosure may be as set forth in Table 3 below:

TABLE 3

| VarName | Label |
|---|---|
| abandone | AbandonedCard from pc08_extra |
| accounti | AccountingDate |
| actionid | ActionID |
| actual_c | ACTUAL_CHECK_IN_DATE |
| actual1 | ACTUAL_CHECK_OUT_DATE |
| address_{—} | address_type |
| address1 | address1 |
| address2 | address2 |
| address3 | address3 |
| affiliat | AffiliationID |
| alias_na | alias_name |
| allow_me | allow_messages_flag from pc08_phone |
| amount | Amount |
| amount_p | AMOUNT_PERCENT |
| annivers | AnniversaryDate from pc08_extra |
| approval | APPROVAL_AMOUNT_CALC_METHOD |
| archived | Archived |
| area | |
| arriva1 | ARRIVAL_STATION_CODE |
| arriva2 | ARRIVAL_CARRIER_CODE |
| arriva3 | ARRIVAL_TRANSPORT_CODE |
| arriva4 | ARRIVAL_DATE_TIME |
| arriva5 | ARRIVAL_ESTIMATE_TIME |
| arriva6 | ARRIVAL_TRANPORTATION_YN |
| arriva7 | ARRIVAL_COMMENTS |
| arrival_{—} | ARRIVAL_TRANSPORT_TYPE |
| atlcity | |
| attracti | AttractionNumber from pc08_extra |
| author1 | AUTHORIZER_ID |
| authoriz | AUTHORIZED_BY |
| availabl | Available |
| averageb | AverageBet |
| bad_flag | bad_flag |
| begin_da | BEGIN_DATE |
| billing_{—} | BILLING_CONTACT_ID |
| billsin | BillsIn |
| biloxi | |
| bonusid | BonusID |
| business | BUSINESS_DATE_CREATED |
| cancel1 | CANCELLATION_REASON_CODE |
| cancel2 | CANCELLATION_REASON_DESC |
| cancel3 | CANCELLATION_DATE |
| cancella | CANCELLATION_NO |
| channel | CHANNEL |
| checkin_{—} | CHECKIN_DURATION |
| city | city |
| coinin | CoinIn |
| coinout | CoinOut |
| color | Color |
| commis1 | COMMISSION_PAID |
| commis2 | COMMISSION_HOLD_CODE |
| commis3 | COMMISSION_PAYOUT_TO |
| commissi | COMMISSION_CODE |
| comp_typ | COMP_TYPE_CODE |
| company_{—} | company_name |
| companyn | CompanyName from pc08_extra |
| compearn | CompEarned |
| compid | CompID |
| complete | Completed |
| confir1 | CONFIRMATION_LEG_NO |
| confirma | CONFIRMATION_NO |
| consumer | CONSUMER_YN |
| contact_{—} | CONTACT_NAME_ID |
| corporat | corporate_customer_id |
| country | country |
| couponid | CouponID |
| credit_c | CREDIT_CARD_ID |
| credit_l | CREDIT_LIMIT |
| creditli | CreditLine |
| criteria | Criteria |
| curren1 | CurrentDayBeginDate from pc08_extra |
| currentd | CurrentDay from pc08_extra |
| currentt | CurrentTrip from pc08_extra |
| custom_r | CUSTOM_REFERENCE |
| date | Date |
| dateenro | DateEnrolled from pc08_extra |
| dealerid | DealerID |
| depart1 | DEPARTURE_STATION_CODE |
| depart2 | DEPARTURE_CARRIER_CODE |
| depart3 | DEPARTURE_TRANSPORT_CODE |
| depart4 | DEPARTURE_DATE_TIME |
| depart5 | DEPARTURE_ESTIMATE_TIME |
| depart6 | DEPARTURE_TRANSPORTATION_YN |
| depart7 | DEPARTURE_COMMENTS |
| departur | DEPARTURE_TRANSPORT_TYPE |
| descript | Description |
| detroit | |
| discou1 | DISCOUNT_PRCNT |
| discou2 | DISCOUNT_REASON_CODE |
| discount | DISCOUNT_AMT |
| display | Display |
| display_{—} | DISPLAY_COLOR |
| dml_seq_{—} | DML_SEQ_NO |
| do_not_m | DO_NOT_MOVE_ROOM |
| dob | dob |
| dollarva | DollarValue |
| email_id | EMAIL_ID |
| email_yn | EMAIL_YN |
| end_date | END_DATE |
| enddate | EndDate |
| endtime | EndTime |
| enrollme | EnrollmentSource from pc08_extra |
| entry_da | ENTRY_DATE |
| entry_po | ENTRY_POINT |
| event_id | EVENT_ID |
| exempt | Exempt from pc08_extra |
| exp_chec | EXP_CHECKINRES_ID |
| extensio | extension from pc08_phone |
| external | EXTERNAL_REFERENCE |
| extracti | ExtractionID |
| failed | Failed |
| fax_id | FAX_ID |
| fax_yn | FAX_YN |
| financia | FINANCIALLY_RESPONSIBLE_YN |
| first_na | first_name |
| folio_1 | FOLIO_TEXT2 |
| folio_cl | FOLIO_CLOSE_DATE |
| folio_te | FOLIO_TEXT1 |
| fromid | PlayerIDFrom |
| frontmon | FrontMoney |
| games | Games |
| gender | gender |
| generati | generation |
| geo_bloc | geo_block |
| geo_coun | geo_county |
| geo_lati | geo_latitude |
| geo_long | geo_longitude |
| geo_trac | geo_track |
| guarante | GUARANTEE_CODE |
| guest_1 | GUEST_LAST_NAME_SDX |
| guest_2 | GUEST_FIRST_NAME_SDX |
| guest_fi | GUEST_FIRST_NAME |
| guest_la | GUEST_LAST_NAME |
| guest_si | GUEST_SIGNATURE |
| guest_st | GUEST_STATUS |
| guest_ty | GUEST_TYPE |
| hostid | HostID |
| hurdle | HURDLE |
| hurdle_o | HURDLE_OVERRIDE |
| id1 | ID1 from pc08_extra |
| imageurl | ImageURL |
| insert_a | INSERT_ACTION_INSTANCE_ID |
| insert_d | INSERT_DATE |
| insert_u | INSERT_USER |
| intermed | INTERMEDIARY_YN |
| intransi | InTransit |
| issuedst | IssuedSite |
| itemnumb | ItemNumber |
| jackpot | Jackpot |
| jobtitle | JobTitle from pc08_extra |
| language | LanguageID from pc08_extra |
| last_dir | LAST_DIRECT_BILL_BATCH_DATE |
| last_nam | last_name |
| last_onl | LAST_ONLINE_PRINT_SEQ |
| last_per | LAST_PERIODIC_FOLIO_DATE |
| lastmark | LastMarkerDate |
| lat | |
| life_s1 | Life_SlotComp |
| life_slo | Life_SlotPoints |
| life_t1 | Life_TableComp |
| linknumb | LinkNumber |
| localmkt | |
| location | Location |
| long | |
| mail_yn | MAIL_YN |
| marketar | |
| marriage | marriage_date |
| master_s | Master_SHARE |
| masterid | MasterID |
| membersh | MEMBERSHIP_ID |
| middle_n | middle_name |
| mnum | Mnum |
| name_id | NAME_ID |
| name_tax | NAME_TAX_TYPE |
| name_usa | NAME_USAGE_TYPE |
| noncashb | NonCashBuyIn |
| origin1 | ORIGINAL_BEGIN_DATE |
| original | ORIGINAL_END_DATE |
| owner_ff | OWNER_FF_FLAG |
| parent_r | PARENT_RESV_NAME_ID |
| party_co | PARTY_CODE |
| payment_{—} | PAYMENT_METHOD |
| periodic | PERIODIC_FOLIO_FREQ |
| phone_fl | phone_flag from pc08_phone |
| phone_id | PHONE_ID |
| phone_nu | phone_number from pc08_phone |
| phone_ty | phone_type from pc08_phone |
| pindiges | PINDigest |
| play_id | PlayerID |
| playerda | PlayerDay |
| playerid | PlayerID |
| playermo | PlayerMod |
| pointmul | PointMultiplier |
| pointsea | PointsEarned |
| pointsmu | PointsMultiplied |
| post_cha | POST_CHARGING_YN |
| post_co_{—} | POST_CO_FLAG |
| postal_c | postal_code |
| posting_{—} | POSTING_ALLOWED_YN |
| pp_lucky | PP_LuckyNumber |
| pp_poolb | PP_PoolBalance |
| pp_total | PP_TotalWon |
| pre_char | PRE_CHARGING_YN |
| prefer1 | preferred_flag_credit |
| preferre | preferred_flag_mailing |
| print_ra | PRINT_RATE_YN |
| promofil | Promofile |
| promoid | PromoID |
| promonam | PromoName |
| pseudo_m | PSEUDO_MEM_TYPE |
| pseudo1 | PSEUDO_MEM_TOTAL_POINTS |
| ptp_sp1 | PTP_SPUsedCents |
| ptp_spus | PTP_SPUsed |
| publicde | PublicDescription |
| purge_da | PURGE_DATE |
| purpose_{—} | PURPOSE_OF_STAY |
| qs_flag | qs_flag |
| qsg_addr | qsg_address_type |
| qsg_bo1 | qsg_box_value |
| qsg_box_{—} | qsg_box_type |
| qsg_buil | qsg_building_name |
| qsg_carr | qsg_carrier_route |
| qsg_del | qsg_delivery_point |
| qsg_deli | qsg_delivery_point_cd |
| qsg_exce | qsg_exception_data |
| qsg_fl1 | qsg_floor_value |
| qsg_floo | qsg_floor_type |
| qsg_ho1 | qsg_house_num_suffix |
| qsg_hous | qsg_house_number |
| qsg_ma1 | qsg_match_last_name |
| qsg_ma2 | qsg_match_last_name1 |
| qsg_ma3 | qsg_match_last_name2 |
| qsg_matc | qsg_match_first_name |
| qsg_name | qsg_name_type |
| qsg_ny1 | qsg_nysiis_city |
| qsg_ny2 | qsg_nysiis_match_last_name2 |
| qsg_nysi | qsg_nysiis_street |
| qsg_rout | qsg_route_type |
| qsg_rs1 | qsg_rsoundex_city |
| qsg_rs2 | qsg_rsoundex_match_last_name2 |
| qsg_rsou | qsg_rsoundex_street |
| qsg_rura | qsg_rural_route_value |
| qsg_st1 | qsg_street_prefix_type |
| qsg_st2 | qsg_street_name |
| qsg_st3 | qsg_street_suffix_type |
| qsg_st4 | qsg_street_suffix_qualifier |
| qsg_st5 | qsg_street_suffix_directional |
| qsg_stre | qsg_street_prefix_directional |
| qsg_un1 | qsg_unit_value |
| qsg_unit | qsg_unit_type |
| qsg_urba | qsg_urbanization |
| rateable | RATEABLE_VALUE |
| raw_ad1 | raw_address2 |
| raw_ad2 | raw_address3 |
| raw_addr | raw_address1 |
| raw_alia | raw_alias_name |
| raw_city | raw_city |
| raw_comp | raw_company_name |
| raw_coun | raw_country |
| raw_crea | raw_create_date |
| raw_dob | raw_dob |
| raw_exte | raw_extension |
| raw_firs | raw_first_name |
| raw_gend | raw_gender |
| raw_la1 | raw_last_activity_date |
| raw_last | raw_last_name |
| raw_marr | raw_marriage_date |
| raw_midd | raw_middle_name |
| raw_phon | raw_phone_number |
| raw_post | raw_postal_code |
| raw_stat | raw_state |
| raw_suff | raw_suffix |
| raw_titl | raw_title |
| redeemco | RedeemCount |
| redeemva | RedeemValue |
| registra | REGISTRATION_CARD_NO |
| reinstat | REINSTATE_DATE |
| reno | |
| report_i | REPORT_ID |
| res_in1 | RES_INSERT_SOURCE_TYPE |
| res_inse | RES_INSERT_SOURCE |
| reservat | ReservationID |
| resort | RESORT |
| restrict | RESTRICTION_OVERRIDE |
| resv_con | RESV_CONTACT_ID |
| resv_nam | RESV_NAME_ID |
| resv_no | RESV_NO |
| resv_sta | RESV_STATUS |
| returned | returned_flag |
| revenue_{—} | REVENUE_TYPE_CODE |
| room_fea | ROOM_FEATURES |
| room_ins | ROOM_INSTRUCTIONS |
| room_ser | ROOM_SERVICE_TIME |
| rp_earne | RP_EarnedDay |
| rp_point | RP_PointAdjustment |
| schedule | SCHEDULE_CHECKOUT_YN |
| seed | Seed |
| sequence | Sequence |
| sguest_f | SGUEST_FIRSTNAME |
| sguest_n | SGUEST_NAME |
| share_se | SHARE_SEQ_NO |
| siteid | SiteID |
| skillcod | SkillCode |
| slot_bil | Slot_BillsIn |
| slot_c1 | Slot_CoinOut |
| slot_c2 | Slot_CompUsed |
| slot_coi | Slot_CoinIn |
| slot_com | Slot_CompEarned |
| slot_gam | Slot_Games |
| slot_jac | Slot_Jackpot |
| slot_p1 | Slot_PointsUsed |
| slot_poi | Slot_PointsEarned |
| slot_r1 | Slot_RP_EarnedDay |
| slot_rp_{—} | Slot_RP_PointAdjustment |
| slot_ses | Slot_Sessions |
| slot_the | Slot_TheoWin |
| slot_tim | Slot_TimePlayed |
| slot_x1 | Slot_XC_Used |
| slot_x2 | Slot_XC_PPEarned |
| slot_x3 | Slot_XC_BSEarned |
| slot_xc_{—} | Slot_XC_RPEarned |
| slotcomp | SlotComp |
| slotpoin | SlotPoints |
| slotvalu | SlotValue |
| source_a | Source_Account |
| source_i | Source_ID |
| source_t | source_type |
| startdat | StartDate |
| starttim | StartTime |
| state | state |
| state2 | |
| status | Status from pc08_extra |
| statusnu | StatusNumber |
| stopcode | StopCode |
| strip | |
| suffix | suffix |
| table_1 | Table_PointsUsed |
| table_3 | Table_ChipsOut |
| table_4 | Table_CompUsed |
| table_am | Table_AmtWagered |
| table_ca | Table_CashBuyIn |
| table_ch | Table_ChipsIn |
| table_co | Table_CompEarned |
| table_ga | Table_Games |
| table_no | Table_NonCashBuyIn |
| table_po | Table_PointsEarned |
| table_se | Table_Sessions |
| table_th | Table_TheoWin |
| table_ti | Table_TimePlayed |
| table_wi | Table_Win |
| tablecom | TableComp |
| tabletyp | TableType |
| tableval | TableValue |
| tax_exem | TAX_EXEMPT_NO |
| theowin | TheoWin |
| tiad | TIAD |
| time | |
| timeplay | TimePlayed |
| title | title |
| toid | PlayerIDTo |
| transid | TransID |
| tripnumb | TripNumber |
| trunc_1 | TRUNC_ACTUAL_CHECK_OUT_DATE |
| trunc_ac | TRUNC_ACTUAL_CHECK_IN_DATE |
| trunc_be | TRUNC_BEGIN_DATE |
| trunc_en | TRUNC_END_DATE |
| tto | TTO |
| tunica | |
| turndown | TURNDOWN_YN |
| type | TYPE |
| udfc01 | UDFC01 |
| udfc02 | UDFC02 |
| udfc03 | UDFC03 |
| udfc04 | UDFC04 |
| udfc05 | UDFC05 |
| udfc06 | UDFC06 |
| udfc07 | UDFC07 |
| udfc08 | UDFC08 |
| udfc09 | UDFC09 |
| udfc10 | UDFC10 |
| udfc11 | UDFC11 |
| udfc12 | UDFC12 |
| udfc13 | UDFC13 |
| udfc14 | UDFC14 |
| udfc15 | UDFC15 |
| udfc16 | UDFC16 |
| udfc17 | UDFC17 |
| udfc18 | UDFC18 |
| udfc19 | UDFC19 |
| udfc20 | UDFC20 |
| udfc21 | UDFC21 |
| udfc22 | UDFC22 |
| udfc23 | UDFC23 |
| udfc24 | UDFC24 |
| udfc25 | UDFC25 |
| udfc26 | UDFC26 |
| udfc27 | UDFC27 |
| udfc28 | UDFC28 |
| udfc29 | UDFC29 |
| udfc30 | UDFC30 |
| udfc31 | UDFC31 |
| udfc32 | UDFC32 |
| udfc33 | UDFC33 |
| udfc34 | UDFC34 |
| udfc35 | UDFC35 |
| udfc36 | UDFC36 |
| udfc37 | UDFC37 |
| udfc38 | UDFC38 |
| udfc39 | UDFC39 |
| udfc40 | UDFC40 |
| udfd01 | UDFD01 |
| udfd02 | UDFD02 |
| udfd03 | UDFD03 |
| udfd04 | UDFD04 |
| udfd05 | UDFD05 |
| udfd06 | UDFD06 |
| udfd07 | UDFD07 |
| udfd08 | UDFD08 |
| udfd09 | UDFD09 |
| udfd10 | UDFD10 |
| udfd11 | UDFD11 |
| udfd12 | UDFD12 |
| udfd13 | UDFD13 |
| udfd14 | UDFD14 |
| udfd15 | UDFD15 |
| udfd16 | UDFD16 |
| udfd17 | UDFD17 |
| udfd18 | UDFD18 |
| udfd19 | UDFD19 |
| udfd20 | UDFD20 |
| udfn01 | UDFN01 |
| udfn02 | UDFN02 |
| udfn03 | UDFN03 |
| udfn04 | UDFN04 |
| udfn05 | UDFN05 |
| udfn06 | UDFN06 |
| udfn07 | UDFN07 |
| udfn08 | UDFN08 |
| udfn09 | UDFN09 |
| udfn10 | UDFN10 |
| udfn11 | UDFN11 |
| udfn12 | UDFN12 |
| udfn13 | UDFN13 |
| udfn14 | UDFN14 |
| udfn15 | UDFN15 |
| udfn16 | UDFN16 |
| udfn17 | UDFN17 |
| udfn18 | UDFN18 |
| udfn19 | UDFN19 |
| udfn20 | UDFN20 |
| udfn21 | UDFN21 |
| udfn22 | UDFN22 |
| udfn23 | UDFN23 |
| udfn24 | UDFN24 |
| udfn25 | UDFN25 |
| udfn26 | UDFN26 |
| udfn27 | UDFN27 |
| udfn28 | UDFN28 |
| udfn29 | UDFN29 |
| udfn30 | UDFN30 |
| udfn31 | UDFN31 |
| udfn32 | UDFN32 |
| udfn33 | UDFN33 |
| udfn34 | UDFN34 |
| udfn35 | UDFN35 |
| udfn36 | UDFN36 |
| udfn37 | UDFN37 |
| udfn38 | UDFN38 |
| udfn39 | UDFN39 |
| udfn40 | UDFN40 |
| uni_card | UNI_CARD_ID |
| update_d | UPDATE_DATE |
| update_u | UPDATE_USER |
| urban | |
| used | Used |
| userid | UserID |
| verified | verified_flag |
| video_ch | VIDEO_CHECKOUT_YN |
| vip_flag | vip_flag |
| walkin_y | WALKIN_YN |
| webenabl | WebEnabled from pc08_extra |
| weblastv | WebLastVisitDate from pc08_extra |
| weblogin | WebLoginCount from pc08_extra |
| win | Win |
| wl_prior | WL_PRIORITY |
| wl_real | WL_REASON_CODE |
| wl_reaso | WL_REASON_DESCRIPTION |
| wl_telep | WL_TELEPHONE_NO |
| xc_bsear | XC_BSEarned |
| xc_enabl | XC_Enable |
| xc_ppear | XC_PPEarned |
| xc_rpear | XC_RPEarned |
| xc_used | XC_Used |
| xlastupd | XLastUpdated from pc08_extra |
| xref | Xref |
| yieldabl | YIELDABLE_YN |
| zip | |

Thus, in a casino example, wagering data may be combined with non-wagering data to predict an increased likelihood a customer may be inclined to gamble when exposed to or offered certain stimuli. Further, various characteristics may be mapped and evaluated. For example, in a casino example, demographic data and data prior to gaming play or outside of gaming play may be mapped to data within consortium data 56.

In some embodiments, customer data is transformed and normalized via mathematical processes and algorithms (including using the data elements in combination, in ratio, in exponentially smoothed, in indexed, in standardized forms, in linear and non-linear equations, in quadratic splines, in non-parametric formulas, in simultaneous multi-stage regressions, and mathematical algorithms) for both individual and grouped data for the purposes of minimizing noise and generating the maximum explanatory power from said data. Integrated activities and behaviors of vendor properties and/or customers from simultaneously and sequentially generated behaviors (e.g., hotel stays, folio activities, gaming play, restaurant visits, electronic accessed media, and entertainment events and venues) may be evaluated.

Additionally, in some embodiments, assessment of the differences among individual customers with diverse behaviors (e.g., in a casino example, diverse gambling behaviors) is also established using customer identity, biometric, fingerprint, profile, cluster, and segment information and may be combined with demographic data outside the vendor property's natural collection processes and matched with one or more factor identity matching algorithms that encompass the customer's location, public records data, financial data, household data, socioeconomic situation, households composition, etc. In some embodiments, the customer data is augmented via stratified sampling techniques (with and without replacement) to create an unbiased representation of the clientele of an individual vendor property or group of vendor properties in the common data instantiations.

In some embodiments, vendor property fields are aligned, integrated, and tracked across different vendor characteristics (e.g., such as those described above and stored as property data 59₁-59ₙ) and are grouped within the consortium data 56 to measure the impacts of such factors on the predictive models of vendor and customer behavior and such model outcomes. Characteristics of the vendor properties and/or vendor property fields may be integrated with the behavior of the customers and/or groups of customers and provided to the predictive models to better interpret the actions of the customers. Characterization of vendor properties and/or groups of vendor properties for understanding the impacts of their behaviors upon their customers and the market may takes place in many dimensions, including creation of metrics evaluating depth of promotion mailing relative to response rates, values, costs and profitability, including Komogorov Smirnoff coefficients, and related measures to separate behaviors of one vendor property from behaviors of other vendor properties.

In some embodiments, the variation in archetype of vendor properties and customers within and across vendor properties is distilled by, for example, creating profiles based upon various characteristics (e.g., individual customers, families or households, class of gaming machines or gaming or entertainment type, specific gaming machine or gaming or entertainment media, shift-time of day, days of week, periods of durability (tenure), seasonality, geography, age, gender, aspects of environment at vendor, mode of gaming play, intensity of gaming play, duration of gaming play, demographic aspects, and a customer's entertainment wallet) as needed for the particular model outcome or predicted value being examined. For example, average daily spend may be created as a target variable in block 502 and may be explained by taking into account all customers at a group of vendor properties grouped into profiles by geographic location. It should be understood that other types of profiles and predictive models that use or respond to profiles may also be generated.

At block 505 the model is estimated/generated using the above-referenced data and variables. In some embodiments, activities and behaviors of vendor properties and/or customers from simultaneously and sequentially generated behaviors, including hotel stays, folio activities, gaming play, restaurant visits, electronic accessed media, and entertainment events and venues) may be integrated and evaluated. At block 506, model results are stored as model data 60. At decisional block 507, a determination is made whether another model needs to be generated. If so, the method returns to block 501. If not, the method proceeds to block 508, where model results may be combined/integrated. For example, models exist at various levels of grouping among customers and vendors, and range from very narrowly applied to a group within a vendor to very broadly applied to all customers of vendors of any type. Selecting the optimal, as indicated by the greatest explanatory or predictive power, model or set of models, is termed model specificity within the ensemble of models. The suite of models that may be combined by error reducing predictive ability maximization algorithms include consortium average models, vendor specific modes, enterprise level models, vendor subset models, models of groups of customers, and individual models themselves. Combining and/or integrating models of different aspects of behavior to generate optimal performance in predictions of customer profitability and responsiveness utilizes weighted averages and error expectations and actualities and are chosen on basis of performance in data set. Different specific sets of models may be appropriate in different cases. It should be understood that other types of models may be combined into ensembles.

At block 509, property-specific data is scored and/or ranked using the combined model results (e.g., and stored as metric data 74). In some embodiments, the results combination performed at block 508 may be carried out differently for each vendor property according to each property's business needs.

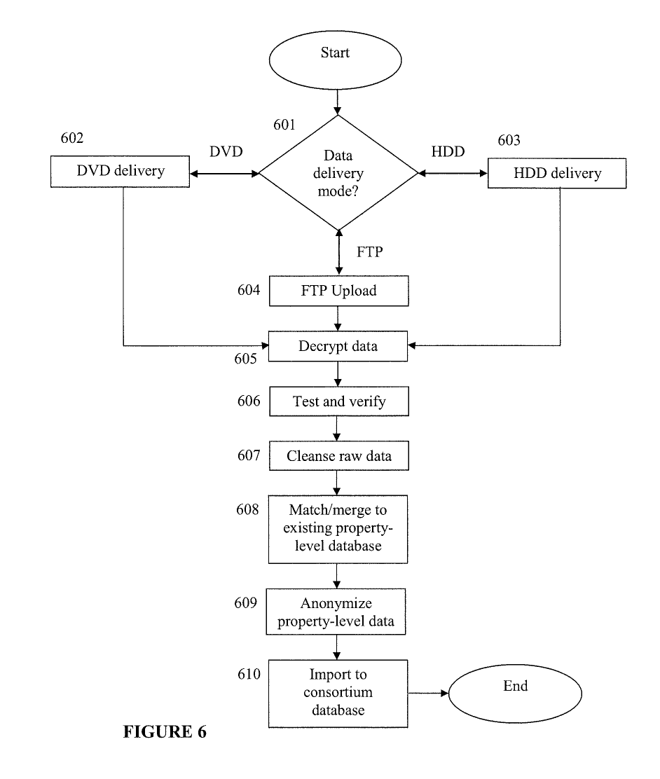

FIG. 6 is a flow diagram illustrating an embodiment of a data delivery and preprocessing method according to the present disclosure. At block 601, a method of data delivery from a particular vendor property to consortium system 17 is specified. In this embodiment, data delivery is accomplished via mail delivery of data digital video disk (DVD)(s)) at block 602, mail delivery of hard drive(s) at block 603, or electronic delivery through an FTP server at block 604. One skilled in the art will readily recognize that these data delivery options are exemplary only. According to various embodiments, the delivery process may be initiated either by the vendor property or by the consortium system 17. In some embodiments, different vendor properties may deliver data to consortium system 17 at different times and according to different fixed or varying schedules. Additionally, some vendor properties may deliver data to consortium system 17 on property-dictated schedules, while others may make data available to consortium system 17 on an on-demand basis according to consortium system 17 specifications. Further, in some embodiments, data may be delivered to consortium system 17 in response to customer activity or a customer event transaction (e.g., reservation, arrival, food order, attending show, etc.). Thus, in some embodiments, aspects of the present disclosure enable real-time or near real-time processing of customer activity to enable corresponding real-time or near real-time predictive modeling of customer behavior, thereby also enabling real-time or near real-time evaluation of incentive or promotional offers that may be likely to be redeemed by the customer. At block 605, the data is decrypted if necessary. At block 606, the data is tested and verified. At block 607, the data is cleansed (described in greater detail below). At block 608, the data is merged or matched into any existing property-level data (e.g., property data 54₁). At block 609, the property data is anonymized, and incorporated into consortium data 56 at block 610.

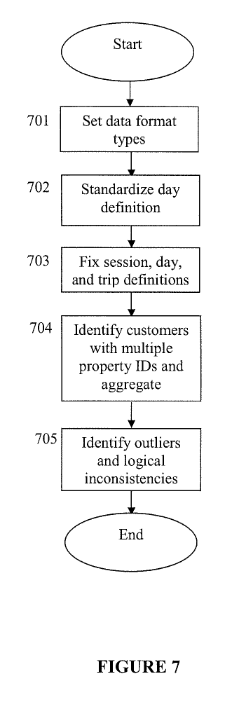

FIG. 7 is a flow diagram illustrating an embodiment of a data cleansing method according to various aspects of the present disclosure that may be performed on vendor property data received by consortium system 17. At block 701, data field formats are specified. At block 702, a standardized definition for a particular data field is specified. For example, in the illustrated embodiment, the data field relates to a “day” (e.g., days of stay at a vendor property). For example, some or all vendor properties may operate twenty-four hours per day; this is particularly true in the casino gaming industry. The conventional 12:00 PM (i.e., midnight) transition time between days may be inappropriate in cases where customer visits often begin prior to 12:00 PM and end after 12:00 PM, as is often the case in the casino gaming industry. Utilizing a later time to define the day transition (e.g., 4:00 AM) may enable more accurate estimates of a casino customers' daily behavior. An additional characteristic of the casino gaming industry is the frequency of collection of gaming behavior data. Such data is typically collected at the session level, where a session is defined as an uninterrupted period of play, typically at a slot machine or gaming table. A customer may have multiple sessions spread throughout each day during which the customer gamed. Raw data provided by vendor properties may include errors or inconsistencies in session, day, and trip measurement. Additionally, sessions, days, and trips are often defined differently across different casino vendor properties depending on individual property's business needs. In some embodiments, session, day, and trip definitions are made consistent across vendor properties and are corrected for errors present in the raw data provided to consortium system 17.

In some embodiments, property-level ID numbers/indicators are used to characterize individual customers. A characteristic of property-level IDs is that individual customers can, for a variety of reasons, be assigned multiple different property-level IDs (e.g., from different vendor properties). Embodiments of the present disclosure identify individual customers with multiple property-level IDs and re-assign the property-level ID such that each individual customer is assigned a single, unique property-level ID at block 704. This process of matching customers at the property-level is functionally similar to the process of matching customers from property-level data to those in consortium data 56 as described in connection with FIG. 3

At block 705, identification of outliers and logical inconsistencies in the raw data is performed. In some embodiments, a portion of the vendor data provided to consortium system 17 by vendor properties includes information reported by customers and/or manually entered by property staff Such data may be susceptible to misreporting or data entry error. As examples of an illogical data point, consider a field including data on customer age that includes data points −13 and 345. These indicate an erroneous entry since they fall outside of the range of viable ages (where viable ages are bounded below by zero and above by, e.g., 120). Outliers include data points that fall considerably outside of the typically observed distribution of observations for a particular data field. As an example, consider a casino customer who places a single bet at a blackjack table for five million dollars, loses, and subsequently exits the casino. Both erroneous/illogical data points and outliers can greatly impact statistical analyses and are processed according to the present disclosure.

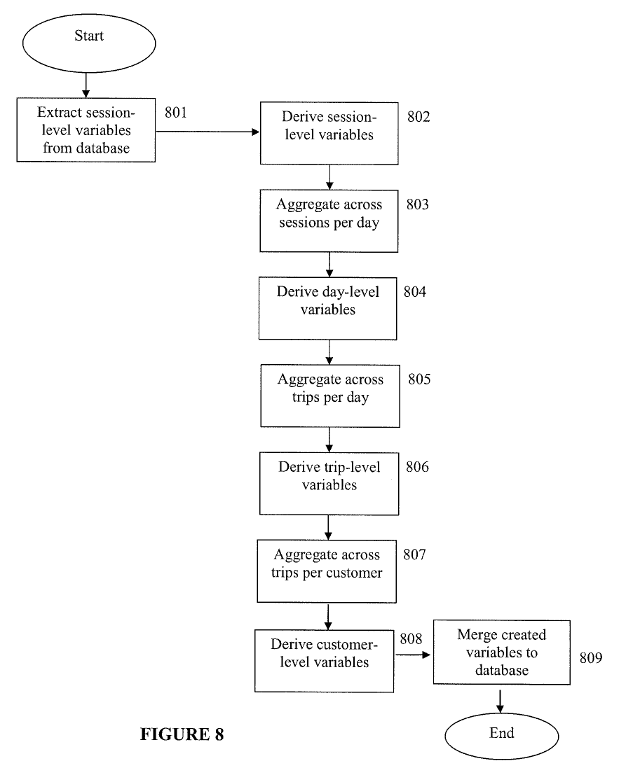

FIG. 8 is a flow diagram illustrating an embodiment of a data aggregation and variable derivation method according to some embodiments of the present disclosure. In some embodiments, this method occurs subsequent to the data delivery, preprocessing, and cleansing depicted in FIGS. 6 and 7. The embodiment illustrated in FIG. 8, the aggregation process is directed toward aggregating gaming session information; however, it should be understood that the method may be applied to other variables. The method begins at block 801, where session-level data is first extracted from particular vendor data (e.g., property data 54₁-54ₙ). Session-level variables are derived from the raw session-level data at block 802. Session-level variables are aggregated across days at block 803. This aggregation is accomplished by applying one or more of various functions to each session-level observation in a given data field. The appropriate function will depend on the format and type of information contained in each individual session-level data field. In some embodiments of the present disclosure, functions employed include, but are not limited to, summation, average, median, minimum, maximum, first, last, and count. At block 804, day-level variables are derived. Day-level data is aggregated to trip-level at block 805 in a similar manner as the prior aggregation. Trip-level variables are derived at block 806, and trip-level data is aggregated to customer-level at block 805 in a similar manner as the prior aggregations. The aggregated and derived variables are merged in consortium data 56 using either property-level ID number or consortium ID number to match observations.

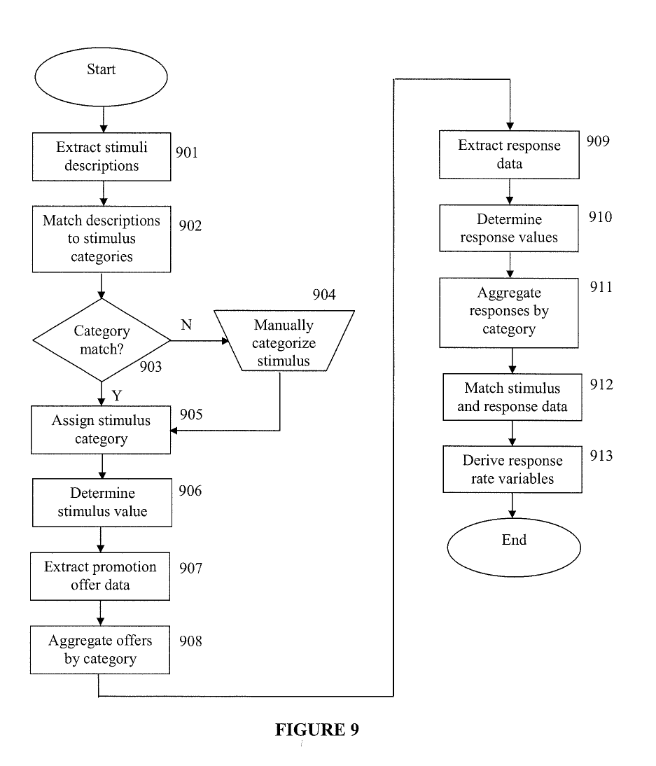

FIG. 9 is a flow diagram illustrating an embodiment of a stimulus-response categorization method of the present disclosure. According to some embodiments of the present disclosure, stimuli comprise promotional offers of various kinds made by consortium vendor properties to their customers. In the method depicted in FIG. 9, data fields describing the nature of such promotions are extracted from property data 54₁-54ₙ at block 901. Descriptive fields are then matched against a standardized list of stimulus categories using a text mining algorithm at block 902. In some embodiments such as the casino and hospitality industries, the following stimulus categories are utilized: 1) free slot play; 2) slot match play; 3) free table play; 4) table match play; 5) free hotel stay; 6) discounted hotel stay; 7) concert tickets; 8) sporting events; 9) food; 10) beverage; 11) air travel; 12) ground transportation; 13) retail credit; 14) spa credit; and 15) cash. If the text mining algorithm successfully matches a particular promotion to a stimulus category at block 903, that stimulus category is assigned to the particular promotion at block 905. If the text mining algorithm is unsuccessful at block 903, the promotion is manually categorized at block 904, and the appropriate category is assigned to the promotion at block 905. Each promotion is assigned a maximum potential dollar value based on a further application of the text mining algorithm at block 906. In some embodiments, categorization of stimuli enable predictive modeling that identifies categories of stimuli typically offered by a particular vendor property.

Subsequent to promotion categorization and valuation, promotion offer data is extracted from consortium data 56 at block 907. In some embodiments, this promotion offer data comprises information about each promotional offer made to each customer in the database. Offer data is then aggregated across each customer at block 908, such that in each period (e.g., each week, each month or each year) the count of promotional offers in each category and the total value thereof is calculated. Promotion response data is extracted from the consortium data 56 at block 909. In some embodiments, promotion offer data comprises information related to each promotional offer redeemed by each customer in the database. For each redemption, the value of that redemption is determined by summing the value across all promotional goods and/or services provided to the customer at block 910. Response data is then aggregated across each customer at block 911, such that in each period (e.g., each week, each month or each year) the count of offers redeemed in each category and the total value thereof is calculated. This method uses the consortium data 56, thereby aggregating stimulus and response data (i.e., promotional offer and redemption data) across non-affiliated vendor properties with potentially different promotion strategies. This approach enables a better understanding of each customer's response behavior and preferences over various types of stimuli, enabling consortium registrants to better target promotional offers/advertising. Stimulus and response data are matched for each customer at block 912, and a variety of response rate and response behavior variables are derived at block 913 (e.g., as depicted in Table 1 above).

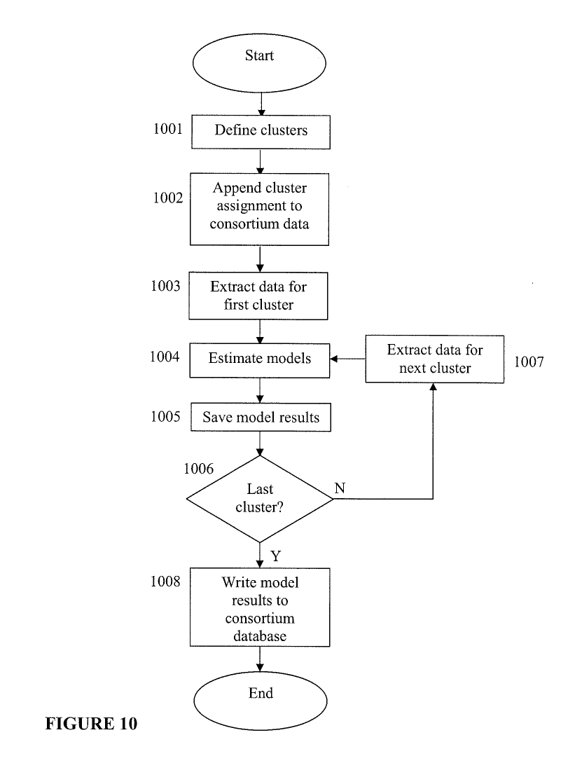

FIG. 10 is a flow diagram illustrating an embodiment of a cluster-level modeling method according to various embodiments of the present disclosure. The method begins at block 1001, where the clusters to be used are defined. Clusters denote unique sets of observations in a database, or in the present disclosure, unique groups of customers found in the consortium database 56. Clusters may be defined by, for example, splitting the consortium data 56 into males and females, or may result from a detailed cluster analysis based on a broad subset of consortium data 56. At block 1002, a new variable denoting cluster assignment is appended to the consortium data 56. At block 1003, data specific to the first cluster is extracted from the consortium data 56, models are estimated on that subset of data at block 1004, and model results are saved/stored to memory 32 at block 1005. At decisional block 1006, if other clusters exist, data related to the next cluster is extracted from the consortium data 56 at block 1007, and the method returns to block 1004. Model results are stored as model data 60 at block 1008.

As described above, model results generated by model generator 40 may be combined according to embodiments of the present disclosure. In some embodiments (e.g., as applied to the casino and hospitality industries), candidate models may include expenditure model 70, frequency model 76, stimuli model 72 and stay model 78. Aspects of the present disclosure accommodate differing preferences across the customer data captured in each of these models for each vendor property. For each vendor property, the results from all of the models may be combined in such a way as to accommodate that property's preferences, and the result is delivered to the vendor property.

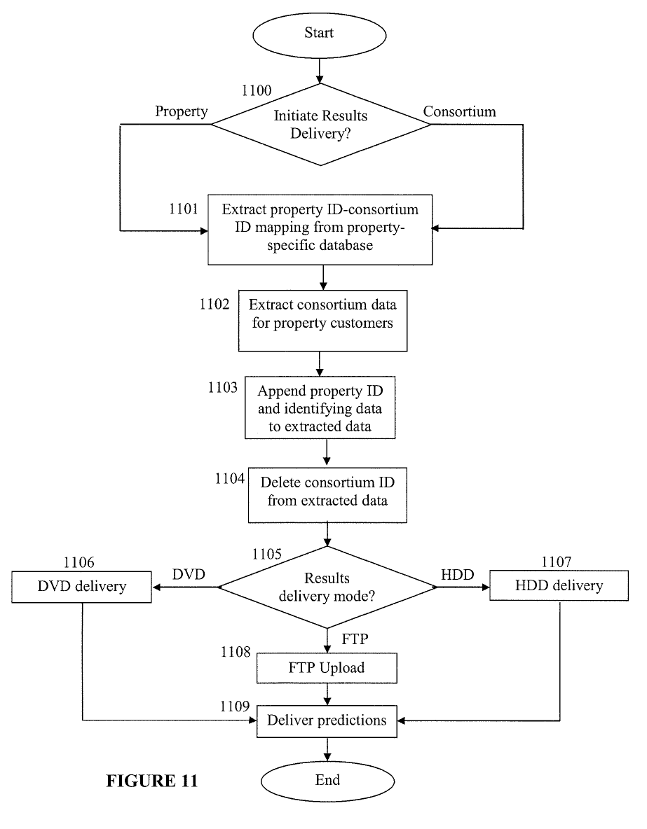

FIG. 11 is a flow diagram of an embodiment of the model results delivery method according to the present disclosure. Model results delivery is initiated either by a vendor property or by the consortium system 17 at block 1100. Under various embodiments of the present disclosure, results delivery may occur on a fixed or varying schedule according to the vendor property's needs, or may occur on an on-demand basis wherein a vendor property instructs the system 17 to initiate model results delivery. Further, in some embodiments model generation and/or model delivery to one or more vendor properties may be in response to a customer activity or a customer event transaction related to or occurring at one or more vendor properties (e.g., real-time or near real-time model generation and/or model delivery). A de-anonymizing operation is performed where the property ID-to-consortium ID mapping is extracted from the property-specific data 52 at block 1101. The consortium ID-to-property ID mapping is used to extract consortium data 56 related to customers of the selected property, including model results, from the consortium data 56 at block 1102. The property ID is appended to the extracted data at block 1103, and the consortium ID is deleted from same at block 1104. The method of model results delivery is specified at block 1105. In some embodiments, results delivery may be accomplished via mail delivery of data DVD(s) at block 1106, mail delivery of hard drive(s) at block 1107, or electronic delivery via (e.g., an FTP server) at block 1108. These results delivery options are illustrative, and it should be understood that a variety of mechanisms capable of delivering the model results in computer-readable and/or human-readable format may be performed. A results file containing, in some embodiments, property ID number, identifying information, consortium-based results fields, and prediction(s)/target stimuli about the property's customers is delivered to the vendor property at block 1109.

In some embodiments, the predictive modeling output/results enables the evaluation of a vendor property's entire customer base. For example, in some embodiments, the predictive model may be used to identify a particular vendor property's most profitable customers and/or the customers predicted to be the most profitable, including, but not limited to, various strategies or promotion categories that may result in the desired customer behavior or that may affect/impact a customer's decision whether to accept/redeem a promotion or undertake a desired behavior.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

What is claimed is:

1. A method comprising:
receiving customer data from a plurality of non-affiliated vendor properties;
anonymizing at least a portion of the received customer data and merging the anonymized customer data from each vendor property into a consortium database; and
generating at least one predictive model of at least one behavior variable associated with at least one customer represented in the consortium database, the predictive model enabling identification of at least one stimuli likely to impact a desired response by the customer based on the predictive model.

2. The method of claim 1, further comprising combining a plurality of predictive models generated for the at least one customer into a metric.

3. The method of claim 1, wherein merging the anonymized customer data comprises merging dissimilar data types related to the at least one customer.

4. The system of claim 1, wherein anonymizing comprises extracting customer identification information from the customer data and assigning a consortium identifier (ID) to the customer data.

5. The method of claim 1, further comprising accessing a lookup table to determine whether a consortium ID has been assigned corresponding to the at least one customer in the consortium database.

6. The method of claim 1, further comprising, after model generation, de-anonymizing at least a portion of the predictive model and communicating the predictive model to at least one vendor property.

7. The method of claim 1, further comprising determining an expenditure model for the at least one customer indicating predictive entertainment expenditures for vendor properties registered to provide customer data to the consortium database and non-registered vendor properties.

8. The method of claim 1, further comprising normalizing the customer data to minimize noise.

9. The method of claim 1, further comprising evaluating simultaneously and sequentially generated behaviors as indicated by the customer data for the predictive model.

10. The method of claim 1, further comprising evaluating property data in combination with the customer data to determine an impact of the property data on the predictive model.

11. The method of claim 1, further comprising generating a plurality of profiles for customers represented in the customer data across different vendor properties.

12. The method of claim 1, further comprising evaluating alignment of characteristics between different vendor properties and determining an impact of the alignment of the characteristics on the predictive model.

13. A system comprising:
a data processing system configured to receive customer data from a plurality of vendor properties, at least a portion of the customer data received in response to a customer event transaction occurring at one of the vendor properties, the data processing system configured to merge the customer data from each vendor property into a consortium database, the data processing system further configured to generate at least one predictive model of at least one behavior variable associated with at least one customer represented in the consortium database, the predictive model enabling identification of at least one stimuli likely to affect a desired response by the customer based on the predictive model.

14. The system of claim 13, wherein the data processing system is configured to combine a plurality of predictive models generated for the at least one customer into a metric.

15. The system of claim 13, wherein the data processing system is configured to merge dissimilar data types received from the vendor properties related to the at least one customer.

16. The system of claim 13, wherein the data processing system is configured to extract customer identification information from the customer data and assign a consortium identifier (ID) to the customer data.

17. The system of claim 13, wherein the data processing system is configured to access a lookup table to determine whether a consortium ID has been assigned corresponding to the at least one customer in the consortium database.

18. The system of claim 13, wherein the data processing system is configured to anonymize at least a portion of the customer data.

19. The system of claim 13, wherein the data processing system is configured to determine an expenditure model for the at least one customer indicating predictive entertainment expenditures for vendor properties registered to provide customer data to the consortium database and non-registered vendor properties.

20. The system of claim 13, wherein the data processing system is configured to classify stimulus and response information included in the customer data across a plurality of different vendor properties based at least on stimulus value, frequency, delivery media and access by a customer.

21. A computer program product for predictive behavior modeling, the computer program product comprising:
a computer readable storage medium having computer readable program code embodied therewith, the computer readable program code comprising computer readable program code configured to:
merge customer data received from a plurality of vendor properties into a consortium database;
generate a plurality of predictive models of at least one behavior variable associated with at least one customer represented in the consortium database, the predictive model enabling identification of at least one stimuli likely to impact a desired response by the customer based on the predictive model; and
combine the plurality of predictive models based on at least one preference indicated by one of the vendor properties.

22. The computer program product of claim 21, wherein the computer readable program code is configured to anonymize at least a portion of the customer data prior to inclusion of the customer data into the consortium database.

23. The computer program product of claim 21, wherein the computer readable program code is configured to generate at least one of the plurality of predictive models in response to receiving an indication of at least one customer event transaction related to at least one of the vendor properties.

24. The computer program product of claim 21, wherein the computer readable program code is configured to generate at least one predictive model based on different promotion strategies used by different vendor properties aggregated into the consortium database.

25. The computer program product of claim 21, wherein the computer readable program code is configured to rank a plurality of customers to which the customer data relates to based on the plurality of predictive models.

26. The computer program product of claim 21, wherein the computer readable program code is configured to analyze the customer data for response-stimuli information and categorize the response-stimuli information in the consortium database.
